(19) United States
(12) Patent Application Publication
(10) Pub. No.: US 2018/0162514 A1
(43) Pub. Date: Jun. 14, 2018

(54) AIRCRAFT COMPRISING A COMMON STRUCTURE FOR SUPPORTING A POWER PLANT AND A LANDING GEAR ELEMENT

(71) Applicant: Airbus Operations SAS, Toulouse (FR)

(72) Inventors: Daniel BELLET, SAINT-LYS (FR); Guillaume GALLANT, LAREOLE (FR)

(21) Appl. No.: 15/840,942

(22) Filed: Dec. 13, 2017

(30) Foreign Application Priority Data
Dec. 14, 2016 (FR) 1662414

(51) Int. Cl. B64C 3/32; B64C 25/34; B64D 27/18; B64D 27/26

(52) U.S. Cl. CPC B64C 3/32; B64C 25/34; B64D 2027/264; B64D 27/26; B64D 27/18

(57) ABSTRACT

An aircraft comprising at least one power plant linked to an airfoil by a power plant support structure comprising a primary structure housed in an aerodynamic fairing. The power plant is formed overhanging behind the airfoil, mostly or wholly above the upper surface of the airfoil. The aircraft comprises a main landing gear comprising at least one landing gear element linked to the airfoil of the aircraft by a support structure. The primary structure and the support structure of the landing gear element are formed by a common structure. The use of such a common structure allows a general optimization of the architecture of the aircraft by virtue of the synergies between the positioning of the power plant, the primary structure of its strut, and the support structure of the main landing gear.

### CROSS-REFERENCES TO RELATED APPLICATIONS

This application claims the benefit of the French patent application No. 1662414 filed on Dec. 14, 2016, the entire disclosures of which are incorporated herein by way of reference.

### BACKGROUND OF THE INVENTION

The present invention relates to the architecture of aircraft, and in particular commercial airplanes for transporting passengers or goods. It relates more particularly to the aircraft with low wings propelled by turbo jet engines mounted on the airfoil of the aircraft.

The power plants of commercial aircraft are, according to the most common aircraft configuration, attached to the airfoil of the aircraft by its bottom surface, called lower surface. The link is produced by a power plant support structure comprising a strut and a link structure with the airfoil.

Each power plant of an aircraft (which can, for example, comprise two or four thereof) is generally installed at the front of this airfoil, that is to say, mounted overhanging in front of the leading edge of the airfoil, under the level of the airfoil. Such a configuration is for example represented in FIG. 1 attached herewith.

The power plant comprises a faired fan (set of blades acting as a propeller), and has a generally cylindrical form. The diameter of the fans tends to increase on modern aircraft, such that their usual positioning results in elongating the length of the landing gear legs of the aircraft to ensure a sufficient ground clearance, particularly in take-off and landing phases.

Such an increase in the length of the landing gear legs is however prejudicial in a number of respects. Firstly, the increase in the length of the legs of a landing gear leads to an increase in its weight. A longer landing gear is heavier. Secondly, it alters the general balance of the aircraft, which leads to an increase in weight. In effect, the wheels of a main landing gear mounted under the airfoil of the aircraft are generally housed in the fuselage (in the bottom part of the fuselage, at the airfoil level) in the retracted position of the gear. An increase in the length of the gear leg requires the axis of rotation of the constituent elements of the main landing gear to be shifted towards the outside of the airfoil, that is to say distancing it from a median plane AA of the aircraft. Now, a power plant cannot be installed in the same position under the airfoil as the main gear for physical incompatibility reasons, particularly because the gear must not be mounted in proximity to the hot jet from the jet engine. That leads to installing the power plants towards the outside of the airfoil, which alters the general balance of the aircraft.

Architectural solutions allowing the use of power plants of large diameter, and/or the reduction of the length of the landing gears are thus desirable.

### SUMMARY OF THE INVENTION

Thus, the invention relates to an aircraft comprising a fuselage and an airfoil comprising two wings, and at least one power plant linked to the airfoil by a power plant support structure comprising a primary structure housed in an aerodynamic fairing. The power plant is formed overhanging behind the airfoil, mostly or wholly above the upper surface of the airfoil. The aircraft further comprises a main landing gear comprising at least one landing gear element linked to the airfoil of the aircraft by a support structure. The primary structure and the support structure of the landing gear element are formed by a common structure. The common structure is linked to the airfoil by the lower surface.

By proposing a common structure to support the power plant and a landing gear element, the invention allows a general optimization of the architecture of the aircraft by virtue of the synergies between the positioning of the power plant, the primary structure of its strut, and the support structure of the main landing gear. The positioning of the power plant overhanging behind such that it absorbs an air stream on the upper surface of the wing allows a positioning of the main landing gear, or of an element of the main landing gear, at the same level of the airfoil, that is to say in one and the same vertical plane as the power plant. That done, the gear element is no longer in the hot air stream produced by the power plant. The power plant and the gear element can be brought closer to the fuselage, especially as the gear element can have a reduced length. Furthermore, a common structure allows a weight saving, especially as, by virtue of the positioning of the power plant, the primary structure no longer needs to be adapted to the eventuality of a landing on the power plant (in case of failure of the landing gear).

According to one embodiment, the common structure is of boxed type.

The common structure can comprise a single rigid structure mounted isostatically on the airfoil. Alternatively, the common structure can comprise a fixed first substructure mounted on the airfoil and constituting the support structure of the gear element, and a second substructure linked to the power plant and fixed removably to the first substructure.

The common structure can notably be linked to a rear spar of the airfoil.

When the gear element is of the type with a brace, the common structure can form a gear rib. When the gear element is of the type with a double brace, the common structure can form a main gear bearing support.

According to one embodiment of the invention, the gear element is of the type with two twin wheels, the main landing gear comprising a gear element linked to each of the wings of the aircraft.

According to one embodiment of the invention, the gear element is of the type with a single wheel, the main landing gear comprising a gear element linked to each of the wings of the aircraft and a gear element with two twin wheels under the fuselage of the aircraft.

According to one embodiment of the invention, the gear element is of the type with a single wheel without braking system, the main landing gear comprising a gear element linked to each of the wings of the aircraft and a gear element with four wheels of bogie type under the fuselage of the aircraft.

The landing gear element can be retractable into the aerodynamic fairing of the power plant support structure. Two strut assemblies can be constructed respectively on either side of the retracted gear element in the aerodynamic fairing of the power plant support structure.

The aircraft can be without gear fairing at the junction between the airfoil and the fuselage.

According to an optional aspect of the invention, the common structure or its aerodynamic fairing can comprise high-lift flap deployment mechanisms. The high-lift flap deployment mechanisms can, for example, comprise runners.

### BRIEF DESCRIPTION OF THE DRAWINGS

Other particular features and advantages of the invention will become more apparent from the following description.

In the attached drawings, given as non-limiting examples:

FIG. 1 schematically represents, by front view, a commercial aircraft according to the prior art;

FIG. 2 represents, by a schematic view in three dimensions, the link between a power plant and the airfoil of an aircraft as produced in the prior art;

FIG. 3 represents, by a schematic view from below, the mechanism of a main landing gear element with a single brace, as known in the prior art;

FIG. 4 represents, by a view similar to that of FIG. 3, a configuration of an aircraft power plant and of a main landing gear element according to an embodiment of the invention;

FIG. 5 schematically represents, by a view in three dimensions, an aircraft having the configuration presented in FIG. 4;

FIG. 6a represents, by a partial front schematic view, the aircraft of FIG. 5;

FIG. 6b represents, by a half-front view of the aircraft, a variant of an embodiment of the invention;

FIG. 7 represents, by a view similar to that of FIG. 5, a second configuration of an aircraft power plant and of a main landing gear element according to an embodiment of the invention;

FIG. 8a represents, by a schematic view, the retracting of a main landing gear element, in the configuration of FIG. 7;

FIG. 8b represents a detail view in cross section of the configuration of FIG. 8a;

FIG. 9 represents, by a view similar to that of FIG. 5, a third configuration of an aircraft power plant and of a main landing gear element according to an embodiment of the invention;

FIG. 10 represents, by a view similar to that of FIG. 5, a fourth configuration of an aircraft power plant and of a main landing gear element according to an embodiment of the invention;

FIG. 11 represents the interaction between high-lift flaps and a device according to an embodiment of the invention;

FIG. 12 represents a configuration of high-lift flaps interacting with a device according to an embodiment of the invention.

### DETAILED DESCRIPTION OF THE PREFERRED EMBODIMENTS

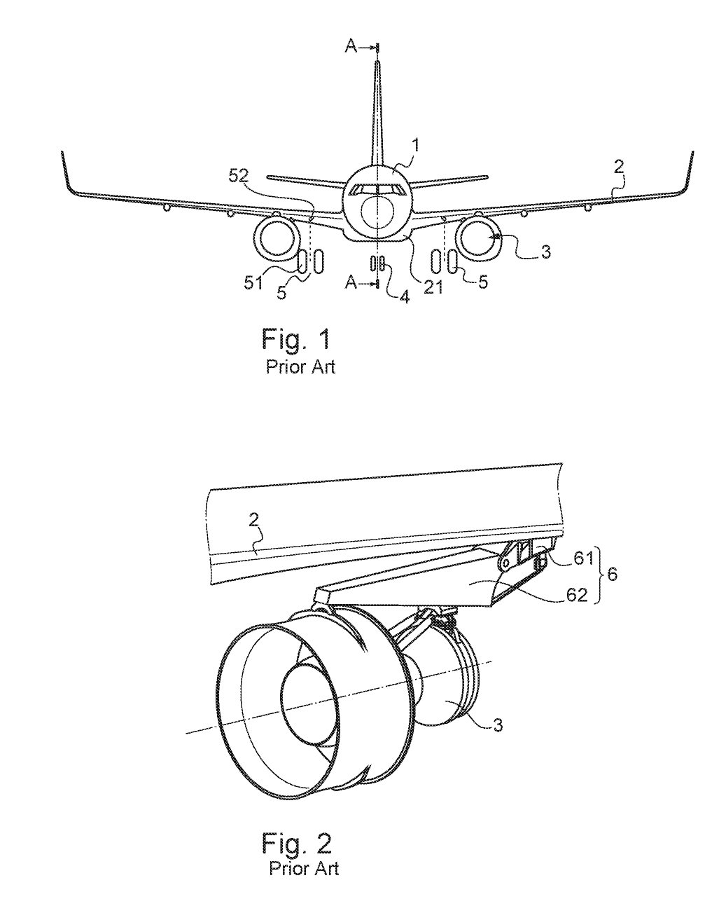

FIG. 1 represents, by front view, a commercial aircraft as known in the prior art. It is an aircraft of the type with low wings comprising a fuselage 1 and an airfoil 2 comprising two wings. Under each wing there is a power plant 3. More specifically, the power plant is located overhanging in front of the airfoil, below the latter, that is to say mostly (or wholly) below the level of the lower surface of the wing.

FIG. 1 also schematically presents a landing gear of a type commonly employed on such an aircraft. The landing gear represented comprises a main gear and a secondary gear 4. The secondary gear 4 is positioned at the nose of the aircraft. The main gear is positioned under the airfoil 2, and comprises two landing gear elements 5.

For each landing gear element 5, FIG. 1 shows the wheels 51 and the pivoting axis 52 of the element. Each landing gear element 5 is mobile, by pivoting about the pivoting axis 52, between an extracted (or deployed) position for the take-off, the landing and the taxiing of the aircraft, and a retracted position during most of the flight of the aircraft. In the closed position, the wheels 51 are retracted under the fuselage 1 and in a gear fairing 21 at the junction of the airfoil 2 and of the fuselage 1.

The main leg of the landing gear element 5 must have a length, measured between the pivoting axis 52 and the axis of rotation of the wheels 51, suitable for guaranteeing a sufficient ground clearance for the power plants 3 for the take-off, the landing and the taxiing of the aircraft.

The separation of the pivoting axis 52 with respect to the median plane AA of the aircraft is thus partly determined by the ground clearance necessary for the aircraft, which is itself a function of the diameter of the power plant 3.

The separation of the pivoting axis in turn conditions the separation of the power plant 3 from the median plane AA, in order to avoid in particular having the landing gear element 5 subjected to the hot air stream generated by the power plant 3.

FIG. 2 represents the link between a power plant 3 (of which only the internal parts involved in this link are represented) and the airfoil 2. The link is ensured by a power plant support structure 6. The power plant support structure 6 comprises an attachment structure 61 rigidly linked to the airfoil and a strut 62, the strut 62 being linked on the one hand to the attachment structure 61, and on the other hand to the power plant 3. The attachment structure 61 and the strut 62 form the primary structure of the power plant support structure 6, that is to say the elements whose essential function is to absorb the loads between the power plant 3 and the airfoil 2. All of the power plant support structure 6 is included in an aerodynamic fairing, not represented in FIG. 2.

The primary structure, and in particular the strut 62, is a so-called “boxed” structure. The strut 62 comprises several ribs linked together by one or more spars, lower and upper, and is closed on its lateral faces by lateral plates, thus forming one or more strut assemblies. So-called “strong” ribs are located in areas of introduction of shearing loads.

Such a construction confers on the structure a great strength and a great flexural and torsional rigidity. That is necessary because of the weight of the power plant 3, and the loads that it generates overhanging the airfoil.

FIG. 3 presents the mechanism of a main landing gear element with a single brace, as is known in the prior art. The system is represented extremely schematically, the gear element being in the retracted position. The gear element has one or more wheels 51 and a pivot axis 52. The gear element further comprises a main leg 53 and a brace 54 articulated in two parts.

Generally, a landing gear element (having this construction or any other construction) is linked to the structure of the aircraft, for example at its airfoil, by a support structure. The support structure of a landing gear element allows the absorption and the transmission to the structure of the aircraft of the loads to which the landing gear element is subjected, particularly in the landing and the taxiing of the aircraft.

In the configuration of FIG. 3, in order to absorb the loads at the pivot axis 52 level, an extension of the structure of the airfoil is necessary, referred to by the expression “gear rib” 55. The gear rib 55 is thus a structural piece that has to absorb significant loads.

In the case of a gear element with a double brace, an extension of the structure of the airfoil is also necessary, to form a main gear bearing support.

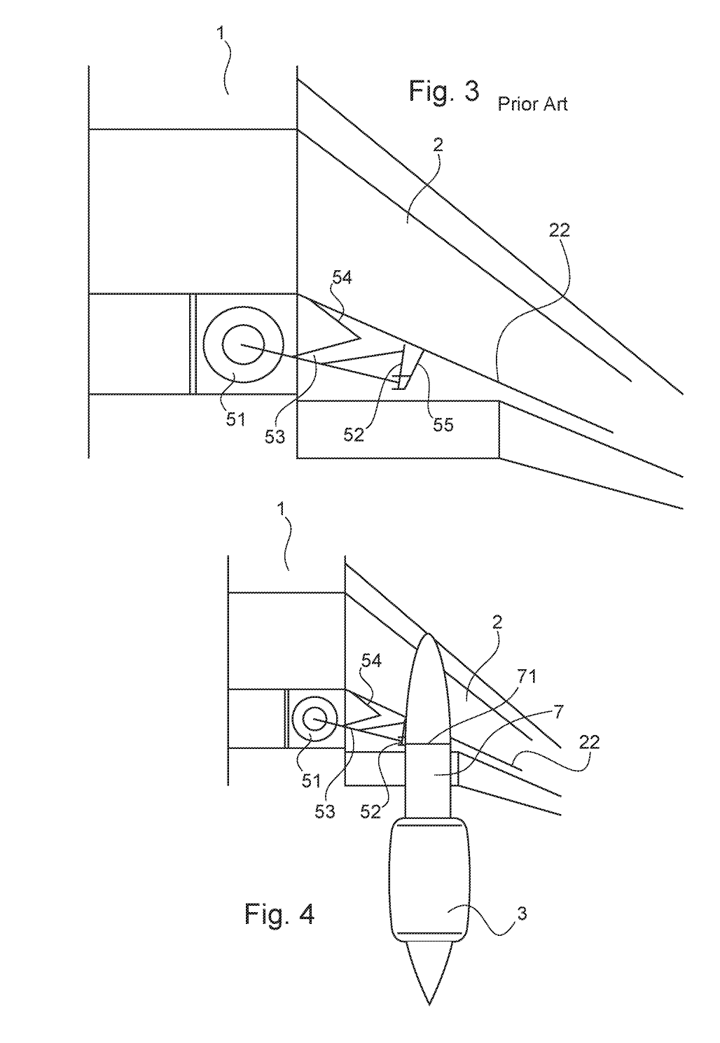

FIG. 4 illustrates, by a view similar to that of FIG. 3, a configuration of an aircraft power plant 3 and of a main landing gear element according to an embodiment of the invention. The gear element illustrated here is of the type with a single brace (just like that of FIG. 3). It comprises, likewise, one or more wheels 51, a main leg 53 and a brace 54 articulated in two parts. The gear element is articulated according to a pivot axis 52.

The power plant 3 is mounted overhanging behind, above the airfoil 2 (that is to say, on the side of the upper surface). The power plant support structure is, for its part, advantageously mounted on the lower surface of the airfoil, and is provided with an aerodynamic fairing.

The power plant 3 is linked to the airfoil by a power plant support structure. The positioning of the power plant 3 allows the gear element to be positioned at the same level, but under the airfoil, on the lower surface side. As represented in FIG. 4, the power plant support structure also serves as a gear rib. For example, a strong rib 71 can serve as the gear rib. More generally, the power plant support structure and the support structure of the gear element are formed by a common structure 7. Thus, the common structure 7 is linked to the airfoil by the lower surface of the airfoil. In particular, the common structure 7 can be linked to a rear spar 22 of the airfoil. In effect, an aircraft wing generally comprises at least one front spar and one rear spar 22, which are elongate structural elements extending in the direction of extension of the wing. Ribs defining the profile of the wing are arranged substantially transversely in relation to the spar. The assembly is covered by a skin (metal or composite panels) linked to the duly formed structure. The rear spar 22, by virtue of its position and its mechanical properties of strength and of rigidity, is adapted to at least partly absorb the loads applied to the airfoil by the common structure 7 (loads from the gear and from the power plant).

The common structure 7 is similar in its construction to the power plant support structure 6 commonly employed, and comprises a boxed primary structure provided with an aerodynamic fairing 72. The primary structure is nevertheless adapted: the absorption of loads induced by the landing gear may require the addition of additional strong ribs (compared to the conventional strut structure for an aircraft power plant) to reinforce the structure in certain areas, while the risk of a landing on the power plants no longer exists, which, on the contrary, makes it possible to lighten the structure in certain areas.

The common structure 7 can comprise a single rigid structure mounted isostatically on the airfoil. Nevertheless, in order to allow an easier dismantling of the power plant 3, for example for the maintenance thereof, the common structure can comprise two substructures linked to one another, namely a fixed first substructure mounted on the airfoil and constituting the support structure of the gear element, and a second substructure linked to the power plant and fixed removably to the first substructure.

Likewise, if the landing gear element is of the type with a double brace, the common structure forms both power plant support structure and support structure of the landing gear element, in that it forms, in particular, a main gear bearing support.

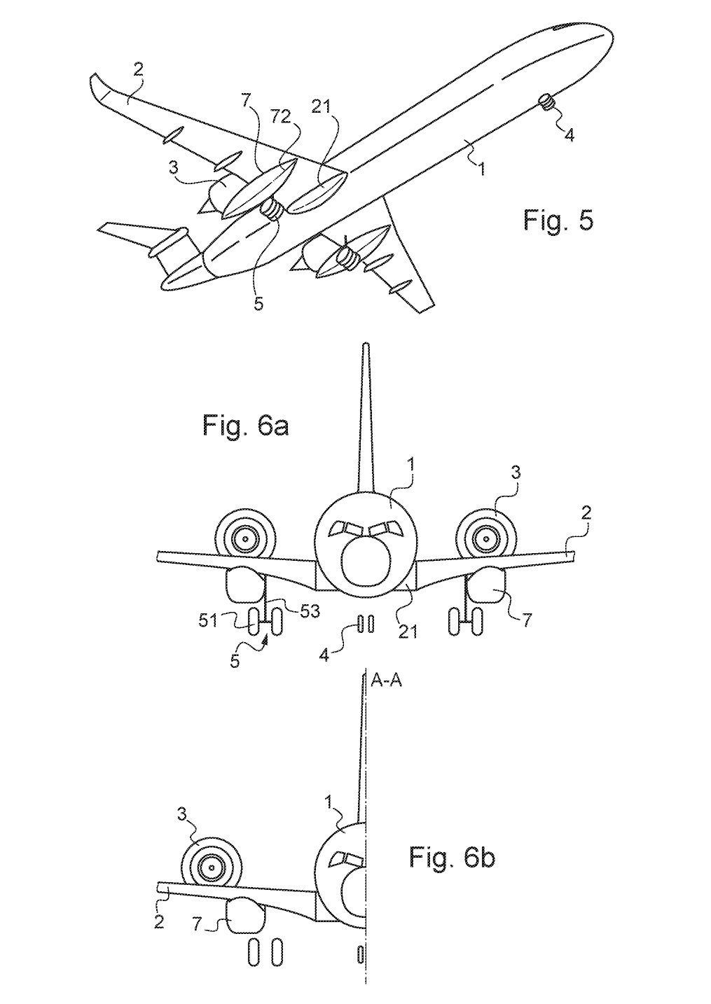

FIGS. 5 and 6a present, by two views in three dimensions, the aircraft configuration of FIG. 4. The landing gear is represented therein in the extracted position.

The main gear 5 comprises two landing gear elements 5, each having two twin-mounted wheels 51. Each landing gear element 5 is retractable by pivoting. Each gear element 5 is housed in the retracted position in the airfoil 2, the wheels 51 being housed, as in the prior art, under the fuselage 1 and in a gear fairing 21 at the junction of the airfoil 2 and of the fuselage 1.

The common structure 7 is housed in an aerodynamic fairing 72, allowing a reduction of the drag, as well as the housing and the protection of components (ducts, etc.) present around the primary structure.

In the configuration of FIGS. 4 to 6a, the kinematics of the main landing gear remain similar to kinematics commonly employed in the prior art, but the height of the gear, determined by the length of the main leg 53, can be reduced and the landing gear elements 5 can be installed at the same level as the power plants 3. That generally allows for a greater freedom in the positioning on the airfoil of the power plants, and, in particular, makes it possible to bring them closer to the median plane AA of the aircraft.

FIG. 6b illustrates one possible positioning of the power plant 3 with respect to the common structure. According to this particular positioning, the axis of the power plant 3 is offset with respect to the vertical plane in which the common structure 7 and its aerodynamic fairing 72 are positioned.

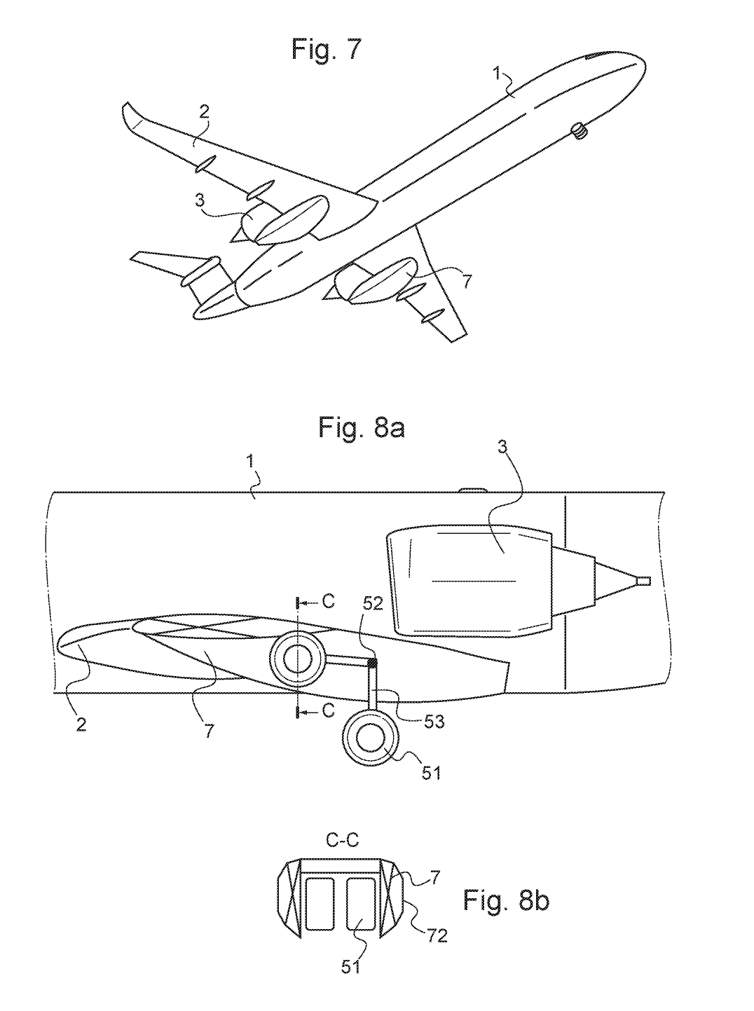

FIGS. 7 and 8a illustrate a second configuration of an aircraft power plant and of a main landing gear element according to an embodiment of the invention. The landing gear is represented in the retracted position in FIG. 7.

The landing gear has the same general configuration as that of FIGS. 5 and 6a: the main gear comprises two landing gear elements 5 each having two twin-mounted wheels 51.

Nevertheless, in the configuration of FIGS. 7 and 8a, the gear is retractable into the common structure 7, that is to say, into the aerodynamic fairing 72 of the power plant support which is also the support of the landing gear element. For that, the pivoting axis 52 of the landing gear element is orthogonal to the median plane AA of the aircraft.

FIG. 8a schematically represents a gear element in the extracted position (that is to say, deployed) and in the retracted position, in the same figure. The landing gear element can have a low height, by virtue of the general configuration of the aircraft and, in particular, of the positioning of the power plant 3. Thus, the main leg 53 of the landing gear element is short, and the gear element can be entirely retracted inside the aerodynamic fairing 72, toward the front thereof. In particular, the detail view 8b represented in FIG. 8b illustrates, by a cross section along the plane CC (represented in FIG. 8a), the positioning of the wheels 51 of the landing gear element in the retracted position with respect to the common structure 7 and its aerodynamic fairing 72. In the exemplary embodiment represented here, the common structure 7 comprises two boxed substructures rigidly linked to one another and situated on either side of the landing gear element when it is retracted.

Thus, the gear element is fixed, via its pivoting axis 52 and its brace or braces to the common structure 7, which therefore constitutes the sole support structure of the landing gear element.

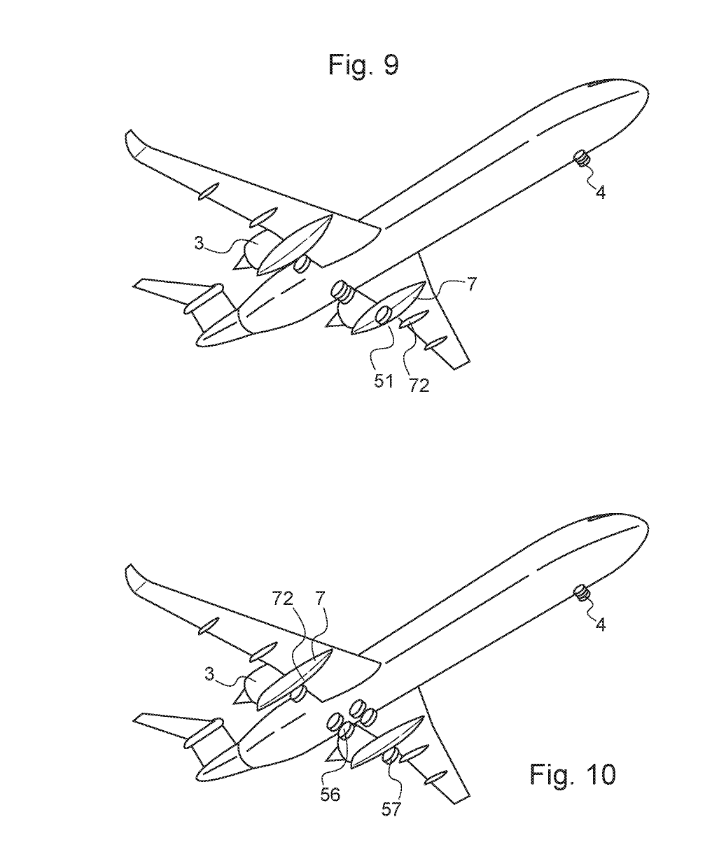

FIG. 9 represents a third configuration of an aircraft power plant and of a main landing gear element according to an embodiment of the invention.

According to the configuration presented in FIG. 9, the main landing gear comprises three landing gear elements: an element under the fuselage 1 comprises two twin-mounted wheels, whereas two elements under the airfoil each comprise a single wheel 51.

The retraction of the gear element under the fuselage can be performed in a way similar to the retraction of the secondary gear 4 (which is under the nose of the aircraft). The retraction of each of the landing gear elements under the airfoil is performed inside the aerodynamic fairing 72 of the common structure 7. Just as in the embodiment presented in FIGS. 7 and 8, the common structure 7 can advantageously comprise two boxed structures. The landing gear element under the corresponding airfoil is retracted in this case between the two boxed structures.

The presence of a single wheel for each landing gear element under the airfoil makes it possible to reduce the width of the common structure 7 and therefore of the aerodynamic fairing 72, which is beneficial for reducing the drag that it induces. In this embodiment, the landing gear fairing situated at the junction of the fuselage 1 and of the airfoil 2 can be wholly or partly eliminated (depending on the volume of the landing gear element under the fuselage).

FIG. 10 represents a fourth configuration of an aircraft power plant and of a main landing gear element according to an embodiment of the invention.

According to the configuration presented in FIG. 10, the main landing gear comprises three landing gear elements: an element under the fuselage 1 comprises four wheels mounted in a so-called “bogie” configuration 56, whereas two elements under the airfoil each comprise a single wheel 51. In this configuration, the wheel 51 of the landing gear element under the airfoil can be of low width and without brakes. Such a landing gear element is commonly called a “stabilizer” 57.

The retraction of the bogie 56 under the fuselage can be performed in a way similar to the retraction of the secondary gear 4 (which is under the nose of the aircraft).

The retraction of each of the stabilizers 57 under the airfoil is performed inside the aerodynamic fairing 72 of the common structure 7. Just as in the embodiment presented in FIGS. 7 and 8, the common structure 7 can advantageously comprise two boxed structures. The corresponding stabilizer is retracted in this case between the two boxed structures.

The low width of the wheel of the stabilizer 57 makes it possible to reduce, even more than in the embodiment of FIG. 9, the width of the common structure 7 and therefore of the aerodynamic fairing 72, which is beneficial for reducing the drag that it induces. In this embodiment, the landing gear fairing situated at the junction of the fuselage 1 and of the airfoil 2 can be wholly or partly eliminated (depending on the volume of the bogie).

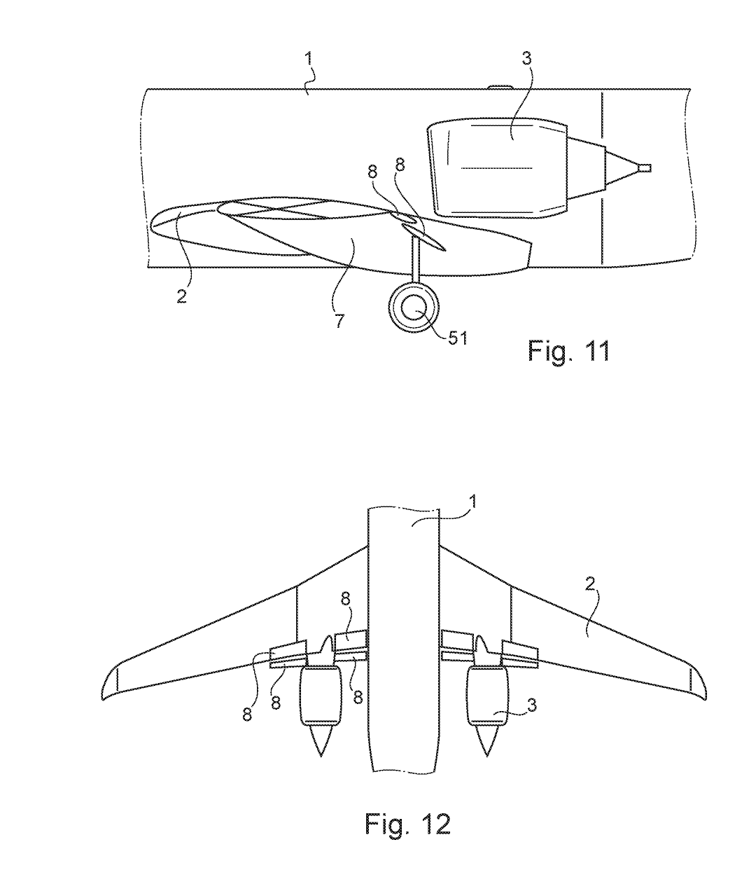

FIG. 11 illustrates a particular aspect of an embodiment of the invention in which the common structure 7 and its aerodynamic fairing 72 are provided with deployment mechanisms for high-lift flaps 8. The aircraft can, for example, be provided with high-lift flaps according to the configuration represented in FIG. 12. Thus, the aircraft can comprise four sets of high-lift flaps 8, each set comprising two flaps. Two sets of internal high-lift flaps are positioned between the fuselage and the common structure 7, and two sets of two high-lift flaps are positioned outside of the common structure 7, that is to say, further away from the median plane AA of the aircraft. The mechanisms formed by the common structure can be runners, or other guiding means, or any type of deployment mechanisms for the high-lift flaps 8.

The invention thus developed makes it possible to optimize the architecture of the aircraft by virtue of the possibilities for synergies between the primary structure of a power plant strut and the support structure of the main landing gear offered by a positioning of the power plant overhanging behind the airfoil, above the latter. The use of a common structure to support the power plant and participate in supporting a landing gear element offers a certain freedom in the configuration of the aircraft, and, for example, makes it possible to bring the power plants closer to the median plane of the aircraft. The pooling of the support functions also allows a reduction of the weight of the aircraft. New kinematics and main landing gear configurations can be employed, allowing the elimination or the reduction of the volume of the aerodynamic fairings such as the gear fairing between the fuselage and the airfoil, which reduces the aerodynamic drag of the aircraft and enhances the performance levels thereof.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising a fuselage and an airfoil comprising two wings, and at least one power plant linked to the airfoil by a power plant support structure comprising a primary structure housed in an aerodynamic fairing,
wherein, said power plant is formed overhanging behind the airfoil, mostly or wholly above an upper surface of said airfoil,
the aircraft further comprising a main landing gear comprising at least one landing gear element linked to the airfoil of the aircraft by a support structure,
wherein the primary structure and the support structure of the landing gear element are formed by a common structure linked to the airfoil by a lower surface of the airfoil.

2. The aircraft according to claim 1, wherein the common structure is of boxed type.

3. The aircraft according to claim 1, wherein the common structure comprises a single rigid structure mounted isostatically on the airfoil.

4. The aircraft according to claim 1, wherein the common structure comprises a fixed first substructure mounted on the airfoil and comprising the support structure of the gear element, and a second substructure linked to the power plant and fixed removably to the first substructure.

5. The aircraft according to claim 1, wherein the common structure is linked to a rear spar of the airfoil.

6. The aircraft according to claim 1, wherein the gear element is of the type with a brace, the common structure forming a gear rib.

7. The aircraft according to claim 1, wherein the landing gear element is of the type with a double brace, the common structure forming a main gear bearing support.

8. The aircraft according to claim 1, wherein the main landing gear comprises a landing gear element linked to each of the wings of the aircraft, each landing gear element being of the type with two twin wheels.

9. The aircraft according to claim 1, wherein the gear element is of the type with a single wheel, the main landing gear comprising a gear element linked to each of the wings of the aircraft and a gear element with two twin wheels under the fuselage of the aircraft.

10. The aircraft according to claim 1, wherein the gear element is of the type with a single wheel without a braking system, the main landing gear comprising a gear element linked to each of the wings of the aircraft and a gear element with four wheels of a bogie type under the fuselage of the aircraft.

11. The aircraft according to claim 1, wherein the landing gear element is retractable into the aerodynamic fairing of the power plant support structure.

12. The aircraft according to claim 2, wherein the landing gear element is retractable into the aerodynamic fairing of the power plant support structure, and wherein two strut assemblies are constructed respectively on either side of the retracted gear element in the aerodynamic fairing of the power plant support structure.

13. The aircraft according to claim 11, wherein the aircraft is without a gear fairing at a junction between the airfoil and the fuselage.

14. The aircraft according to claim 1, wherein the common structure comprises high-lift flap deployment mechanisms.

15. The aircraft according to claim 14, wherein the high-lift flap deployment mechanisms comprise runners.

16. The aircraft according to claim 14, wherein the aerodynamic fairing comprises high-lift flap deployment mechanisms.

17. The aircraft according to claim 16, wherein the high-lift flap deployment mechanisms comprise runners.
